(19) United States
(12) Patent Application Publication
(10) Pub. No.: US 2018/0158033 A1
(43) Pub. Date: Jun. 7, 2018

(54) SYSTEMS AND METHODS FOR AUTOMATED WASTE COLLECTION

(71) Applicant: MasterCard International Incorporated, Purchase, NY (US)

(72) Inventors: Jeffrey D. Woods, O'Fallon, MO (US); Christopher Eric Mullen, St. Peters, MO (US); Rick Unnerstall, O'Fallon, MO (US)

(21) Appl. No.: 15/371,599

(22) Filed: Dec. 7, 2016

(51) Int. Cl. G06Q 10/00; G06Q 10/06; G06Q 20/10; G05D 1/02

(52) U.S. Cl. CPC G06Q 10/30; G06Q 10/06314; G05D 1/0274; G05D 1/0285; G06Q 20/10

(57) ABSTRACT

The present disclosure provides for an automated waste collection system, the automated waste collection system in communication with a client device and a payment processor, including a vehicle device onboard a waste collection vehicle and comprising a vehicle transceiver, a first processor, and a first memory, a bin computing device mounted to a waste collection bin and comprising a bin transceiver, a second processor, and a second memory, and a geofence defined by location data. The vehicle device and said bin computing device are configured to communicate wirelessly with one another to verify, based on the geofence location data, a user account associated with a user that has requested a waste collection service.

### BACKGROUND

This disclosure relates generally to waste collection systems and, more specifically, to systems and methods for automated waste collection.

Smart phone and web-based application technology have offered businesses and individuals more opportunity for on demand and scheduled services. Clients are able to easily initiate the scheduling of such waste collection services from the interface of a wireless device. Clients further expect a fast response, and fast and secure payment options, following the issuance of a service request.

At least some waste collection services provide a weekly waste collection pickup on a designated day that is scheduled when the service is signed up for by the user, and billed monthly to the user. This offers a user little to no control over when waste will be collected. This leads to instances when a user's waste collection bin is filled, but service is not rendered until days later, or in some cases, where the dumpster is not full on the day of pickup and the pickup occurs anyway. Thus, there is a need for a fast and convenient system for on demand scheduling of waste collection.

### BRIEF DESCRIPTION

In one aspect, the disclosure provides an automated waste collection system, the automated waste collection system in communication with a client device and a payment processor, including a vehicle device onboard a waste collection vehicle and comprising a vehicle transceiver, a first processor, and a first memory, a bin computing device mounted to a waste collection bin and comprising a bin transceiver, a second processor, and a second memory, and a geofence defined by location data. The vehicle device and the bin computing device are configured to communicate wirelessly with one another to verify, based on the geofence location data, a user account associated with a user that has requested a waste collection service.

In another aspect, the disclosure provides an automated waste collection method including receiving a communication from a client device requesting the scheduling of a waste collection service, scheduling a waste collection service in response to the communication, transmitting a signal to a vehicle device onboard a vehicle scheduled to perform the waste collection service, communicating wirelessly with a bin computing device to perform the waste collection service, and verifying a user account and verifying a payment.

### BRIEF DESCRIPTION OF THE DRAWINGS

FIG. 1 illustrates an example of one embodiment of a vehicle device onboard a waste collection vehicle communicating with a bin computing device coupled to a waste collection bin.

FIG. 2 is a simplified block diagram of a monitoring system that includes a geofence for creating and monitoring transactions initiated within geofence zones.

FIG. 3 illustrates an example configuration of a client device such as a client device as described herein.

FIG. 4 illustrates an example configuration of a server system such as a server system as described herein.

FIG. 5 illustrates an example of one embodiment of an automated waste collection system as described herein.

FIG. 6 illustrates an example of one embodiment of a registration system for registering a user account for the automated waste collection system as shown in FIG. 4.

FIG. 7 shows an example configuration of a user account database within a computing device, along with other related computing components, that may be used to create, organize, and monitor a plurality of user data associated with a user.

FIG. 8 is an example of a method performed using the automated waste collection system shown in FIG. 5.

FIG. 9 is an example of another waste collection method.

FIG. 10 is an example of yet another embodiment of a waste collection method.

### DETAILED DESCRIPTION

The disclosure herein describes systems and methods for waste collection, wherein a merchant (e.g. waste collector) schedules and performs a waste collection service in response to a user request. A user, after registering a user account, uses a user computing device or a client device, such as a smart phone, to initiate the scheduling of a waste collection service. A merchant responds to the user's request, and performs the waste collection service. The user then offers a payment for the waste collection service to the merchant through an automatic payment linked with the user account and a payment card number. The user can schedule a waste collection service on demand, or the user can establish a pre-determined frequency at which the waste collection service will occur. Payment is made to the merchant through a card issuer and processed over a payment network. The waste collection system shall herein be described as the system, and the two phrases shall be understood to be used interchangeably. The waste collection service includes dispatching a vehicle to a pre-determined location to perform waste collection. The vehicle can be any vehicle provided by the merchant suitable for waste collection.

The system includes a vehicle device that includes a vehicle transceiver, and a first processor in communication with a first memory, wherein the first processor is configured to receive data from a server system. In one embodiment, the vehicle device can attach to the vehicle configured for waste collection. The server system can be associates with at least one of a merchant, a payment card issuer, a payment network, and/or a third party. The vehicle device receives a signal from the server system to perform the waste collection service requested by the user. The vehicle device is configured to process the signal received by the server system using the first processor, and to determine the time and location of the waste collection service to be performed. The vehicle device further is configured to communicate with the client device using a wireless connection. This allows the user to remotely monitor the activity of the vehicle device and the activity of the vehicle. Monitoring the activity of the vehicle device includes, but is not limited to, monitoring the communications with a bin computing device (described below), and monitoring the GPS coordinates of the vehicle device.

In one embodiment, the vehicle device has an interface, a processor, and a memory, wherein the driver of the vehicle can interact with the vehicle device. The interface provides the driver with a visual display that notifies the driver of at least one of a location, a user account, and user payment data. The driver may initiate communication with the server system by way of interacting with the vehicle device. For example, the driver may interact with the vehicle device in a way that signals the server system that the driver is in route to the location of a bin for a waste collection service. In one embodiment, the vehicle device is configured to notify the driver of surrounding bins within the area, wherein the area is defined by a geozone (described in detail below).

The system further includes a bin computing device that includes a bin transceiver, and a second processor in communication with a second memory. The bin computing device attaches to a waste collection bin. In one embodiment, the bin is any bin suitable to hold and/or store waste. The bin computing device and the vehicle device communicate with one another through a wireless connection, such as but not limited to, a Bluetooth® connection. The bin computing device includes a unique bin ID that is used to identify the specific bin computing device and identify the bin it is attached to. The bin computing device is further configured to communicate with the client device using a wireless connection. This allows the user to remotely monitor the activity of the bin computing device and the activity of the bin. Monitoring the activity of the bin computing device includes monitoring communications with a vehicle device, communications with the server system, and communications with the payment card issuer. Monitoring the activity of the bin includes, but is not limited to, monitoring the current level of waste in the bin.

In the example embodiment, the vehicle device and bin computing device communicate using a passive wireless connection. In one embodiment, the bin computing device includes an internal power source, and communicates with the vehicle device using active wireless communication.

In one embodiment, the bin computing device includes an interface that allows the user to interact with the bin computing device. The interface provides the user with a visual display for interaction.

In one embodiment, a geofence is at least one of a set of GPS coordinates and/or a range of GPS coordinates that define a geographic area. Multiple bin computing devices can be included within a single geofence. In another embodiment, the geofence is a zip code.

Registration for a user account occurs when a user registers on a merchant app or a merchant web site for a user account, wherein the user account includes but is not limited to user identification data, location data, and payment data. The user account is managed by the merchant. Once registered, the user can access the user account from various sources, including but not limited to, an app on a smart phone, a web site, or by phone.

In one embodiment, the vehicle device communicates wirelessly with the bin computing device when the vehicle device is within a specified range of the bin computing device.

For example, the vehicle may communicate with the bin computing device when it is within 20 feet of the bin computing device. When in the specified range of the vehicle device, the bin computing device sends a data signal to the vehicle device that includes, but not limited to, the bin computing device ID and user account data. User account data may include location data, user identification data, and payment data. The user identification data includes, but is not limited to, a name and an account number associated with the user. Location data includes but is not limited to an address where the bin is located and geofence data. Payment data includes, but is not limited, to a payment card number and an account balance.

The system further provides account verification and payment verification of the bin computing device and the user account before the waste collection service is performed by the merchant. Account verification of the bin computing device and the user account includes matching the user account data, such as user identification data, location data, and payment data, with the linked bin computing device ID. As described below, the bin computing device ID is registered with the specific user account during an account registration process. In one embodiment, account verification occurs automatically when the vehicle device is within a pre-determined range of the bin computing device. In another embodiment, account verification only occurs when a driver initiates communication between the vehicle device and the bin computing device. In yet another embodiment, account verification occurs at a separate time before the waste collection service is provided.

In the example embodiment, account verification occurs when the bin computing device sends the bin computing device ID to the vehicle device. The vehicle device communicates the bin computing device ID to the server system in order to match the bin computing device ID with the user account data.

During account verification, if the account data and the bin computing device ID do not match, the verification fails, and no waste collection service is performed. In one embodiment, when account verification fails, the user may receive a notification that the account verification has failed and that no service has been performed. If, during account verification, the account data and the bin computing device data match, the account verification is successful, and payment verification can begin. When verification is successful, the server system communicates with the vehicle device by sending a verification success notification. In one embodiment, the vehicle device includes a light and is configured to visually display a verification success notification to the driver of the vehicle, indicating that service should be performed. It should be understood that this is only one example of a verification notification, and that other types and forms of verification notifications can be used with the system.

In one embodiment, payment verification occurs only after account verification is successful. In another embodiment, payment verification occurs simultaneously with account verification. Payment verification ensures the security of the payment and that the user has the available funds to pay for the waste collection service before it is performed by the merchant. During registration, a user is assigned a bin computing device ID. The user provides user information including account data to the server. The server links the user information to the bin computing device ID. In some cases, the server will also communicate with the payment processor to have the account data converted to a token ID. Thus, the server stores a token ID associated with the user and links it to a bin computing device ID. The bin computing device is associated with a bin computing device ID. The bin computing device ID is a unique ID that identifies the waste collection bin. This is stored at the server system.

In one embodiment, during payment verification, the bin computing device wirelessly sends at least one of the bin computing device ID and the token ID to the vehicle device. The vehicle device sends the at least one of the bin computing device and token ID to the card issuer. In another embodiment, the vehicle device communicates the at least one of the bin computing device ID and token ID to the server system, wherein the server system processes the at least one of the bin computing device ID and the token ID, and thereafter communicates the at least one of the bin computing device ID and the token ID to the card issuer. In both embodiments, the card issuer processes the at least one of the bin computing device ID and the token ID, and verifies the payment through a payment network. The payment network approves or denies the payment, and subsequently the payment verification.

If the payment verification is denied, no waste collection service is performed by the merchant. In one embodiment, if payment verification is denied, the card issuer sends a notification to the client device that the payment verification has been denied, and that no waste collection service was performed. In one embodiment, if payment verification is successful or approved, the server system and/or the vehicle device receives a verification success notification. In one embodiment, the vehicle device includes a light and is configured to visually display a verification success notification to the driver of the vehicle, indicating that service should be performed. It should be understood that this is only one example of a verification notification, and that other types and forms of verification notifications can be used with the system.

If both the account verification and payment verification is successful, the waste collection service is performed. In one embodiment, once the waste collection service is performed, the server system sends a notification to the client device that the waste collection service has been performed. The notification includes at least one of, but is not limited to, a receipt for the transaction and a notification message. In one embodiment, the server system sends the user an SMS text message that the waste collection service has been performed.

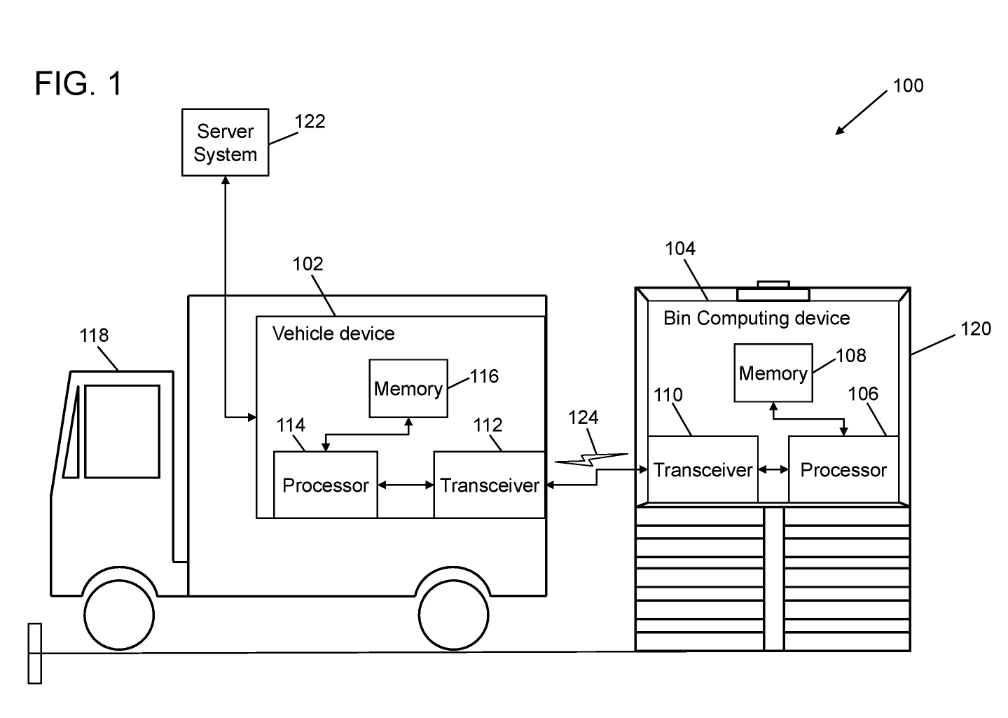

FIG. 1 illustrates an example embodiment of a vehicle device on board a waste collection vehicle communicating with a bin computing device coupled to a waste collection bin. A waste collection vehicle 118 is within a predetermined range of waste collection bin 120. A vehicle device 102 onboard vehicle 118 communicates with a bin computing device 104 coupled to bin 120. Vehicle device 102 includes a transceiver 110, a processor 106, and a memory 108. Bin computing device 104 includes a transceiver 112, a processor 114, and a memory 116. When in range, vehicle device 102 sends an initial signal wirelessly to transceiver 112. The initial signal is processed by processor 114, and a response signal is sent to transceiver 110. The response signal is processed by processor 106, and stored within memory 108.

In one embodiment, the initial signal sent from vehicle device 102 to bin computing device 104 triggers bin computing device 104 to send a bin computing device ID 124 to vehicle device 102. Vehicle device 102 processes bin computing device ID 124 using processor 106. Vehicle device 102 then sends an account signal to a server system 122 for an account verification.

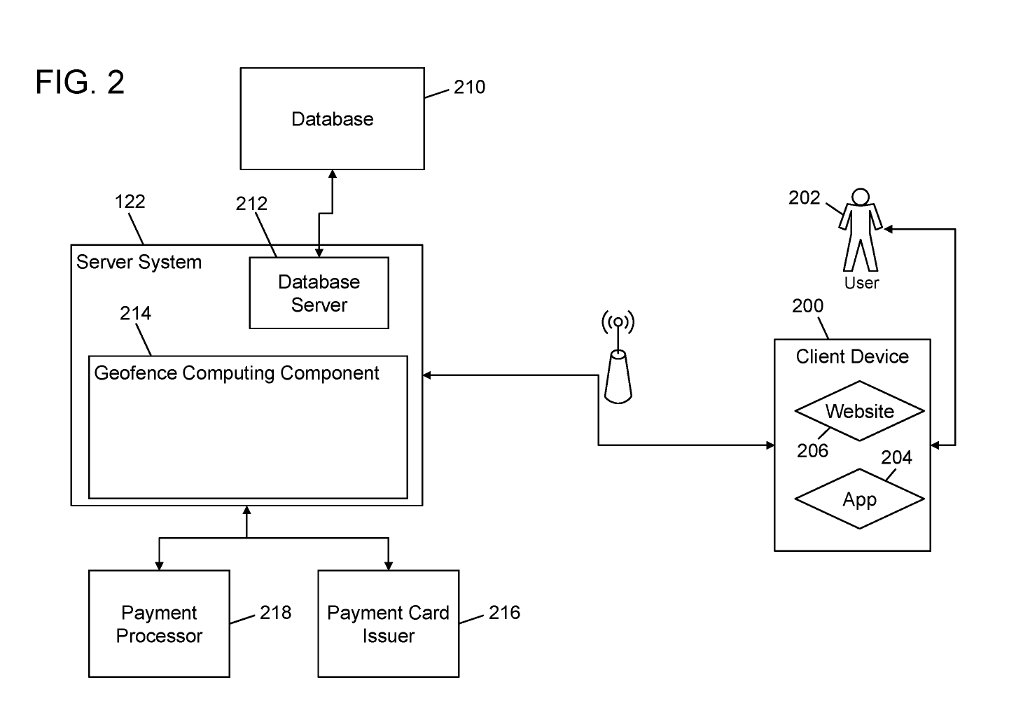

FIG. 2 is a simplified block diagram of a geofence monitoring system that includes server system 122. Server system 122 includes a geofence computing component 214 for creating and monitoring geofence zones. Geofence computing component 214 is in communication with at least one client device 200. In the example embodiment, client device 200 is a mobile device, such as any mobile device capable of interconnecting to the Internet including a web-based phone, also referred to as smart phone, personal digital assistant (PDA), a tablet, or other web-based connectable equipment. In an alternative embodiment, client device 200 is a desktop computer or a laptop computer. Client device 200 may be associated with a user 202, for example, a cardholder. Client device 200 may be interconnected to the Internet through a variety of interfaces including a network, such as a local area network (LAN) or a wide area network (WAN), dial-in connections, cable modems and special high-speed ISDN lines. In some embodiments, client device 200 includes a software application 204 (i.e., a service app) installed on client device 200. In additional embodiments, client device 200 displays a customized website 206 using a web browser installed on client device 200. In further embodiments, client device 200 is in communication with a geopositioning network 208 to facilitate GPS functionality of client device 200. As described above, geofence computing component 214 receives and collects geopositioning data from client device 200.

In the example embodiment, server system 122 is in communication with a payment processor 218 and/or a payment card issuer 216. Payment processor 218 and/or server system 122 may be associated with an interchange network (not shown). Server system 122 is configured to receive transaction data from payment processor 218.

Server system 122 including a database server 212 connected to a database 210, which contains information on a variety of matters, as described below in greater detail. In one embodiment, database 210 is centralized and stored on server system 122. In an alternative embodiment, database 210 is stored remotely from server system 122 and may be non-centralized. Database 210 may store transaction data including data relating to merchants, merchant locations, and cardholders. Database 210 also stores cardholder data relating to zone creation and organization. In particular, database 210 stores zones created by cardholders, wherein each zone is associated with one or more account identifiers, such as payment card numbers, of a cardholder. In some embodiments, database 210 stores data necessary to host the customized website and/or the service app accessible by cardholders for zone creation and organization.

In the example embodiment, server system 122 is configured to receive transaction data from payment processor 218. In another embodiment, server system 122 is further configured to receive geopositioning data from geopositioning network 208. Geopositioning network 208 may be a component in a larger geopositioning network. Geofence computing component 214 is configured to determine whether a bin computing device 104 is inside or outside of a zone based on the transaction data and/or the geopositioning data.

Although only one payment card issuer 216, one payment processor 218, one user 202, and one client device 200 are illustrated, it should be understood that the geofence monitoring system may include any number of payment card issuers 216, users 202, payment network 218, and/or client devices 200 in communication with server system 122.

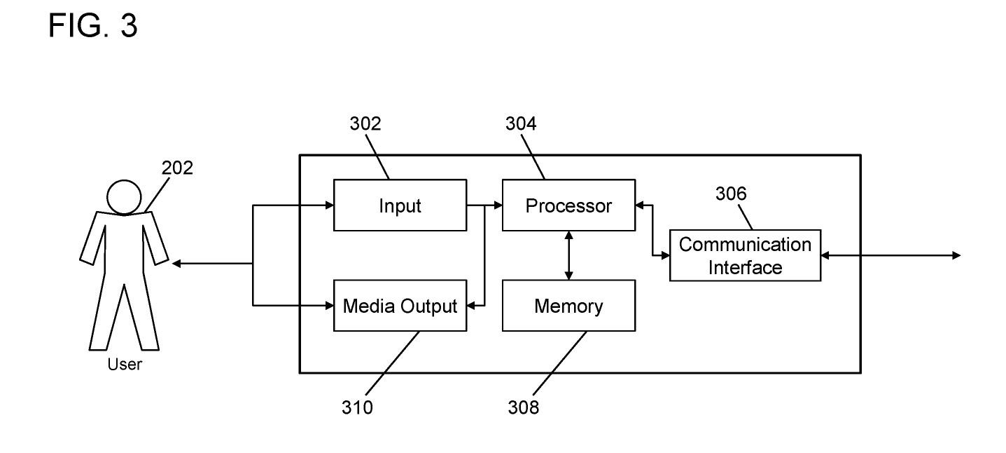

FIG. 3 illustrates an example configuration of a client device 200 operated by a user 202, such as a cardholder. User system 200 may include, but is not limited to, a smart phone, a tablet, and a website. In the example embodiment, client device 200 includes a processor 304 for executing instructions. In some embodiments, executable instructions are stored in a memory area 308. Processor 304 may include one or more processing units, for example, a multi-core configuration. Memory area 308 is any device allowing information such as executable instructions and/or written works to be stored and retrieved. Memory area 308 may include one or more computer readable media.

Client device 200 also includes at least one media output component 310 for presenting information to user 202. Media output component 310 is any component capable of conveying information to user 202. In some embodiments, media output component 310 includes an output adapter such as a video adapter and/or an audio adapter. An output adapter is operatively coupled to processor 304 and operatively couplable to an output device such as a display device, a liquid crystal display (LCD), organic light emitting diode (OLED) display, or “electronic ink” display, or an audio output device, a speaker or headphones.

In some embodiments, client device 200 includes an input device 302 for receiving input from user 202. Input device 302 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 310 and input device 302. Client device 200 may also include a communication interface 306, which is communicatively couplable to a remote device such as the payment processor. Communication interface 306 may include, for example, a wired or wireless network adapter or a wireless data transceiver for use with a mobile phone network, Global System for Mobile communications (GSM), 3G, or other mobile data network or Worldwide Interoperability for Microwave Access (WIMAX), or an 802.11 wireless network (WLAN).

Stored in memory area 308 are, for example, computer readable instructions for providing a user interface to user 202 via media output component 310 and, optionally, receiving and processing input from input device 302. A user interface may include, among other possibilities, a web browser and client application. Web browsers enable users, such as user 202, to display and interact with media and other information typically embedded on a web page or a website. A client application allows user 202 to interact with a server application from a server system.

In some embodiments, client device 200 includes a global positioning system (GPS) sensor integral with communication interface 306, input device 302, or as a separate component. The GPS sensor is configured to receive signals from a plurality of GPS satellites and to determine the location of the GPS sensor and the mobile device using the signals. More specifically, the GPS sensor determines geolocation information for client device 200. The geolocation information may be calculated, for example, by communicating with satellites using communication interface 306. The GPS sensor determines the location of the mobile device and, therefore, the location of mobile device user (i.e., user 202). For example, the GPS sensor functions as a GPS receiver and receives signals from at least three GPS satellites. The received signals include a time stamp at which the signal was sent and a satellite identifier. The GPS sensor is configured to “reverse engineer” the locations of the GPS satellites and, from the satellites' positions, determine its own location based on how long it took (from the time each signal was sent) to receive each signal. In some cases, the GPS sensor is configured to analyze other data streams to supplement this location-determination process. For example, the GPS sensor may access cellular tower data (e.g., by “pinging” a nearby cell tower) to determine its approximate location and, from that information, only analyze signals from the three nearest GPS satellites. Client device 200 may additionally or alternatively include other components such as an accelerometer, gyroscope, and/or any other position and/or location-determining components. Client device 200 may be used to download a merchant app in connection with a user account.

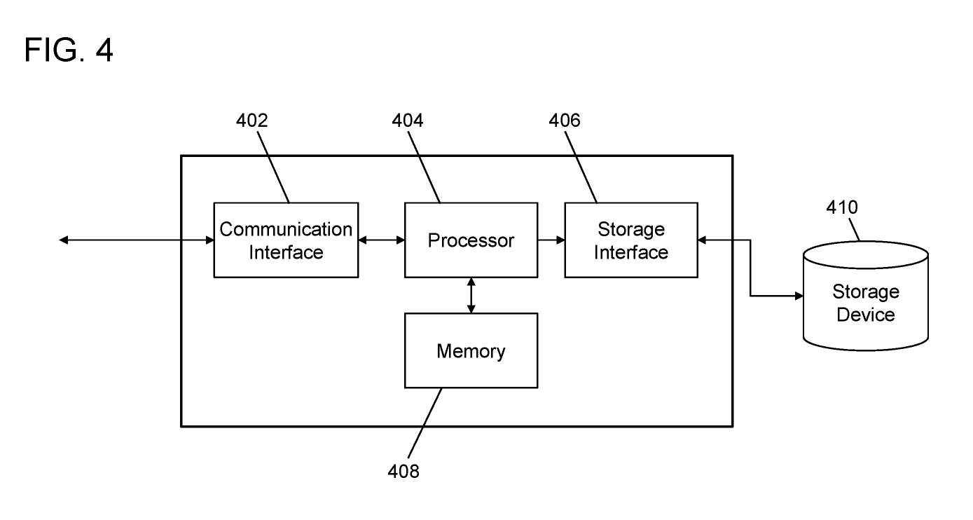

FIG. 4 illustrates an example configuration of a server system 122 such as a server system 122 as described herein. Server system 122 is a database used and managed by at least one of a merchant, such as a waste collection merchant, a payment card issuer, a payment card network, and a third party, used to store user account data, and send, receive, and process signals from various sources. Server system 122 includes a processor 404 for executing instructions. Instructions may be stored in a memory area 408, for example. Processor 404 may include one or more processing units (e.g., in a multi-core configuration) for executing instructions. The instructions may be executed within a variety of different operating systems on the server system 122, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 404 is operatively coupled to a communication interface 402 such that server system 122 is capable of communicating with a remote device such as a client device 200 or another server system 122. For example, server system 122 may be a server system, wherein communication interface 402 may receive data from payment processor 218.

Processor 404 may also be operatively coupled to a storage device 410. Storage device 410 is any computer-operated hardware suitable for storing and/or retrieving data. In some embodiments, storage device 410 is integrated in server system 122. For example, server system 122 may include one or more hard disk drives as storage device 410. In other embodiments, storage device 410 is external to server system 122 and may be accessed by a plurality of server systems 122. For example, storage device 410 may include multiple storage units such as hard disks or solid state disks in a redundant array of inexpensive disks (RAID) configuration. Storage device 410 may include a storage area network (SAN) and/or a network attached storage (NAS) system.

In some embodiments, processor 404 is operatively coupled to storage device 410 via a storage interface 406. Storage interface 406 is any component capable of providing processor 404 with access to storage device 410. Storage interface 406 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 404 with access to storage device 410.

Memory area 408 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

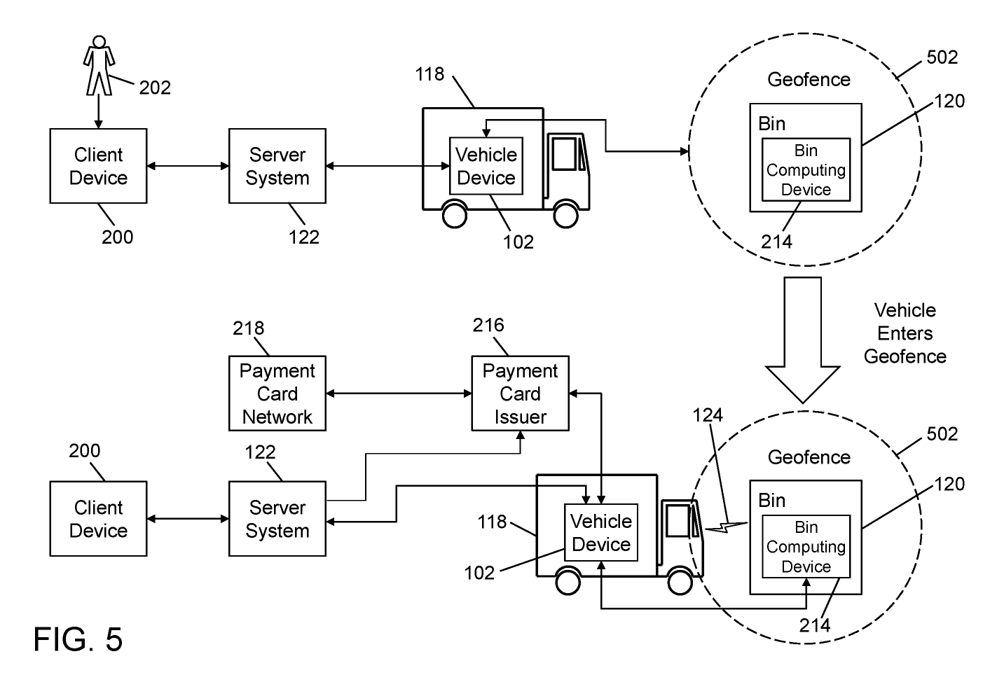

FIG. 5 shows a diagram of an example embodiment of a waste collection and payment system 100. In one embodiment, user 202 uses client device 200 to send a client signal to server system 122. As described above, in one embodiment, client device 202 includes at least one of a tablet and a smart phone device. The client signal requests at least one of an on demand or a scheduled waste collection service. The waste collection service is scheduled for at least one of a residence and a business. The client may choose to prepay for the service through the client device.

Server system 122 processes the client signal received from client device 200, and links the user's waste collection service request with the appropriate or matching user account. The details of the user account may be accessed by the user 202 through the client device 200. Server system 122 then sends a server signal to vehicle device 102. The server signal, once received by vehicle device 102, indicates to the driver of vehicle 118 that a waste collection service has been scheduled. In one embodiment, server system 122 searches the area surrounding the user 202, by processing the data from the user account, and signals a vehicle device 102 within the same area.

In one embodiment, vehicle device 102 is configured to attach to a vehicle 118. Vehicle 118 may be any vehicle 118 suitable for waste collection. In another embodiment, vehicle device 102 is a portable device that can be carried to the waste collection bin 120 by a merchant driver. Vehicle device 102 is detachable from the merchant vehicle 118.

In one embodiment, vehicle device 102 includes a controller (not shown) and an interface (not shown) that are configured to output a visual display. The visual display displays, to the driver, all relevant data associated with the server signal, such as but not limited to, a user address, a bin location, estimated time of waste collection service, and user payment data.

Geofence 502 is a plurality of location data linked to a location server system 122 and vehicle device 102, including but not limited to GPS coordinates. A user account is associated with specific location data, allowing server system 122 to coordinate with merchant drivers the location of the respective bin computing device 104. In one embodiment, a notification is sent to client device 200 when vehicle device 102 enters the location associated with user's 202 location, or geofence 502. This enables user 202 to know of vehicle device's 102 physical locations within the area, as to better estimate the timing of the waste collection service performance. In another embodiment, other users 202 with user accounts that reside the same location and geofence 502 as user 202 who requested a waste collection service can be sent a notification that merchant vehicle 118 is in the area. The notified users 202 can then request an on demand or scheduled waste collection service. Vehicle device 102 is configured to receive location data, such as GPS coordinates associated with geofence 502. Vehicle device 102 is further configured to analyze the location data, and determine if the associated geofence 502 is linked with the user account from the respective user waste collection service request. If the location data is associated with the user account of the respective user 202, vehicle device 102 notifies the driver of the vehicle 118 to proceed to the respective bin 120 for performance of the waste collection service.

In one embodiment, bin computing device 104 is configured to attach to bin 120, such as a garbage bin. Bin computing device 104 is configured to communicate wirelessly with vehicle device 102 when within a predetermined range of vehicle device 102. Each bin computing device 104 further includes bin computing device ID 124, that is a unique number associated with a specific bin computing device 104. Bin ID 124 is registered to a user 202 through user account registration. Thus, server system 122 associates bin computing device 104 with the user's 202 account data.

When within the predetermined range, bin computing device 104 is configured to automatically transmit a bin computing device ID 124 to vehicle device 102. In one embodiment, vehicle device 102 is then configured to process bin computing device ID 124, and determine if it matches with the user's 202 user account data. In another embodiment, vehicle device 102 sends server system 122 bin computing device ID 124, and server system 122 processes bin computing device ID 124 to determine if it matches with the user's 202 user account data. This is referred to as account verification. In one embodiment, if bin computing device ID 124 is associated with user's 202 user account data, account verification is successful, and payment verification is initiated. If the bin computing device ID 124 does not match with the plurality of user account data, account verification fails, and no waste collection service will be performed. This prevents the fraudulent use of bin computing device 104 by a user 202 who is not associated with the corresponding user account of the waste collection service request.

When payment verification by payment card issuer 216 and payment network 218, or by the server system 122 in an embodiment where the payment card issuer 216 is the server system 122, is successful, the payment card issuer 216 sends a notification to the at least one of server system 122 and vehicle device 102. A notification signal (not shown) on the vehicle device 102 is triggered, and the vehicle driver performs the waste collection service.

After waste collection service has been performed, a notification is sent to client device 200, notifying the user 202 that waste collection service has been performed. In one embodiment, server system 122 is configured to send a notification of payment to client device 200. The notification of payment is at least one of a payment receipt, and/or a message through email or SMS text.

In one embodiment the bin computing device 104 is configured to include a bin threshold detector (not shown), or detector. The bin threshold detector is a scanning mechanism included within the bin computing device 104 that detects when a pre-determined amount of waste is applied to bin 120. The bin threshold detector includes but is not limited to optic laser sensors for detecting a specific height of waste pile up within bin 120, and/or a weight detector that triggers when a specified amount of weight is applied within bin 120. The bin threshold detector may be configured to be adjustable. For example, user 202 can adjust the bin threshold detector to trigger when bin 120 is half-way filled with waste, or alternatively, user 202 can adjust the bin threshold detector to trigger when bin 120 is completely filled.

In one embodiment, bin computing device 104 is configured to send a signal to at least one of vehicle device 102, server system 122, and client device 200 when the bin threshold is triggered. When the signal is sent to client device 200, user 202 is able to schedule a waste collection service with the merchant using the client device 200 in the above described manner. If the signal is sent to server system 122, the merchant may automatically schedule a waste collection service, or can notify user 202 that bin 120 is filled. In one embodiment, bin computing device 104 may be configured to send a signal to multiple vehicle devices 102 within the same location and geofence 502 as bin computing device 104.

In another embodiment the bin threshold detector is configured to trigger a diagnostic at a pre-determined frequency. The diagnostic determines whether or not the bin threshold has been applied to bin 120. For example, the bin threshold detector may be configured to perform a diagnostic every 12 hours to determine if the bin threshold has been applied to bin 120.

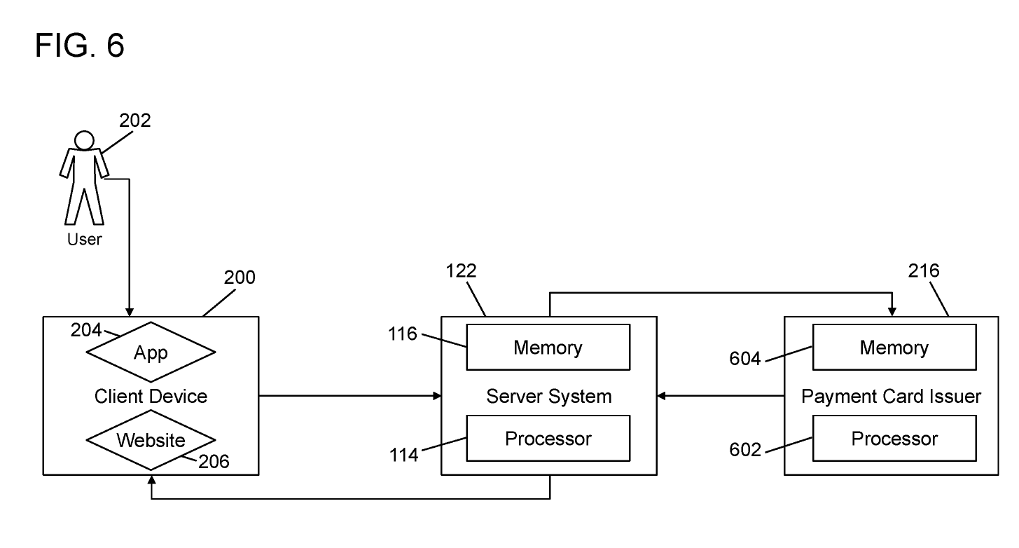

FIG. 6 illustrates an example of one embodiment of a registration system for setting up a user account for the waste collection system 100 as shown in FIGS. 1 and 5. User 202 interacts with client device 200 by way of at least one of app 204 or web site 206. User 202 enters user data into the user account, wherein the user data becomes linked with the specific user account. The server system 122 receives, processes, and stores the user account data by way of processor 404 and memory 408. The server system 122 is further configured to send a plurality of payment data associated with the user account to payment card issuer 216, wherein payment card issuer 216 includes a processor 602 in communication with a memory 604. In one embodiment, server system 122 is the same as payment card issuer 216.

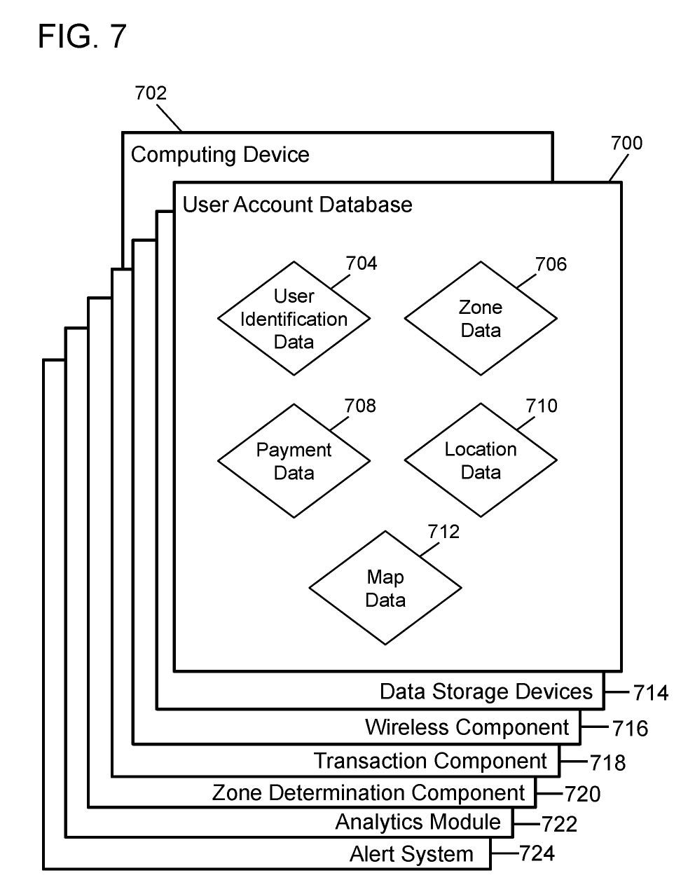

FIG. 7 shows an example configuration of a user account database 700, within a computing device 702, along with other related computing components, that may be used to create, organize, and monitor a plurality of user data associated with a user account. In some embodiments, computing device 702 is the same or similar to server system 122. User account database 700 is coupled to several separate components within computing device 702, which perform specific tasks.

In the example embodiment, database 700 includes zone data 706, location data 710, user identification data 704, payment data 708 and map data 712. Zone data 706 includes data associated with geofence 502, such as, but not limited to, a zip code. Location data 710 includes information associated with locations of payment card transactions and point-of-sale devices. Map data 712 includes data associated with a plurality of maps. User identification data 704 includes, but is not limited to, a user name, a user address, and a user phone number. Payment data 708 includes, but is not limited to, a card number, a credit history, and a billing address.

Computing device 702 includes the database 700, as well as data storage devices 714. Computing device 702 also includes a wireless component 716 for receiving and analyzing wireless data to determine a cardholder's location. Computing device 702 also includes a transaction component 718 for correlating the locations of payment card transactions with merchants and cardholders, and for matching account identifiers. An analytics module 722 is included for analyzing transaction data of a cardholder to make merchant recommendations and/or zone recommendations. Further included is a zone altering module 720 for altering a zone based on transaction data or cardholder input. Computing device 702 also includes an alert module 724 for transmitting an alert to a cardholder or an issuer.

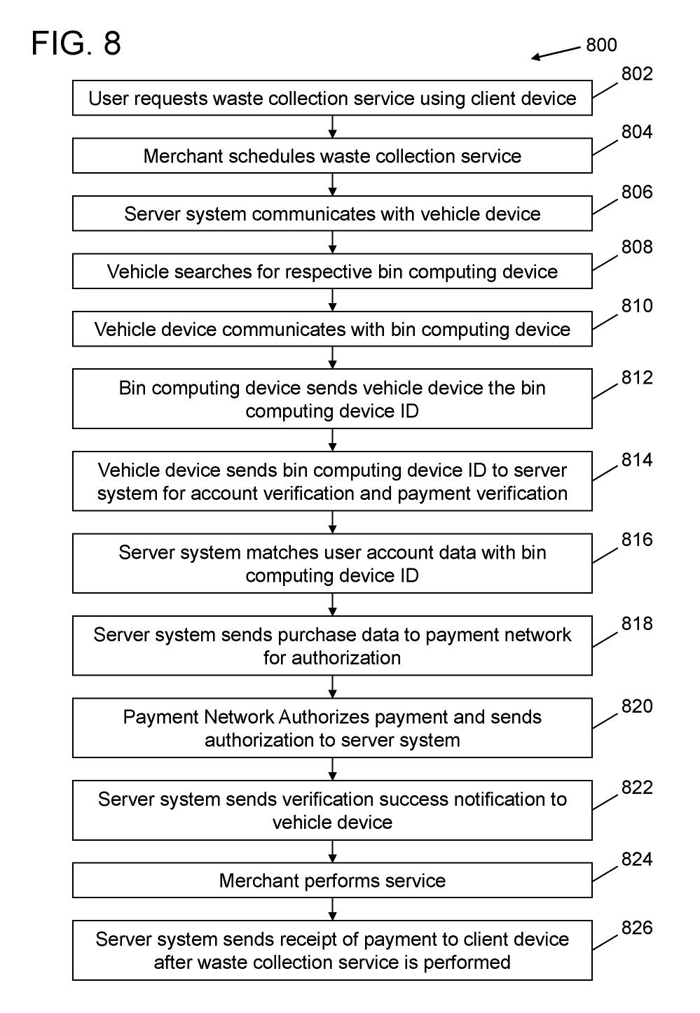

FIG. 8 is an example of a method performed using the waste collection and payment system shown in FIG. 5. The user requests a waste collection service using the client device in step 802. The merchant then schedules the waste collection service in step 804. The server system then communicates with the vehicle device in step 806. In one embodiment, the server system searches for a vehicle device within the same geofence as the respective bin computing device in order to provide a shorter time frame between the scheduling of a waste collection service and performing the waste collection service. The user is notified of the date and approximate time of the scheduled service. The vehicle device then searches for the respective bin in step 808. Once the bin computing device is located, the merchant vehicle drives within a specified range of the bin computing device. The vehicle device then communicates with the bin computing device in step 810. If the vehicle device communicates with a bin computing device outside the parameters of the appropriate geozone linked to the user account and bin computing device, no waste collection service will be rendered.

The bin computing device then sends the vehicle device the bin computing device ID through a response signal, which is step 812. The vehicle device then sends the bin computing device ID to the server system for account verification and to payment verification in step 814. In one embodiment, account verification and payment verification occur at the same time. In another embodiment, account verification is performed before payment verification. If the server system matches the user account data with the bin computing device ID, then account verification is successful, which is step 816. The server system then sends the purchase data to a payment network for authorization, which is step 818. The payment network then authorizes the payment in step 820. The server system then sends a verification success notification (step 822) to the vehicle device, and the merchant performs the waste collection service, which is step 824. After the waste collection service is complete, the server system sends a receipt of payment to the client device, which is step 826.

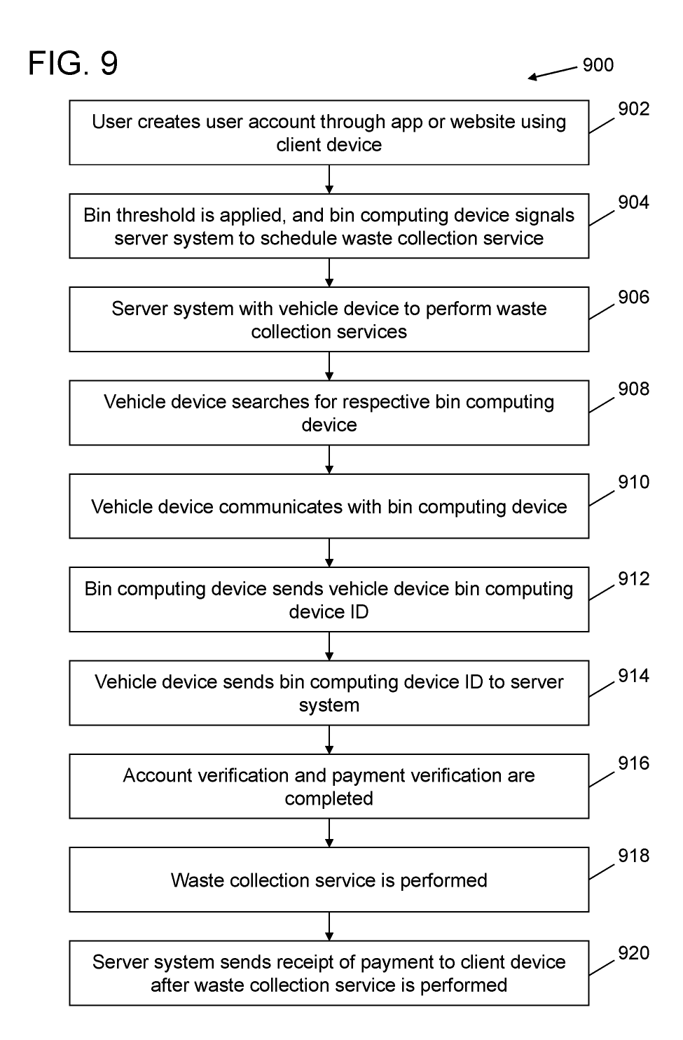

FIG. 9 is an example of another waste collection method 900. In this embodiment, the user creates a user account through an app or website using the client device, which is step 902. The bin computing device includes a bin detector for detecting a bin threshold in this embodiment. Step 904 includes the bin computing device signaling the server system to schedule a waste collection service after the bin threshold has been triggered. Once a specified amount of waste is placed in the waste collection bin, the bin threshold is triggered, and a waste collection service is automatically scheduled in step 906. The vehicle device then searches for the respective bin in step 908. Once the bin computing device is located, the merchant vehicle drives within a specified range of the bin computing device. The vehicle device then communicates with the bin computing device in step 910. If the vehicle device communicates with a bin computing device outside the parameters of the appropriate geozone linked to the user account and bin computing device, no waste collection service will be rendered.

The bin computing device then sends the vehicle device the bin computing device ID through a response signal, which is step 912. The vehicle device then sends the bin computing device ID to the server system for account verification and to payment verification in step 914. In one embodiment, account verification and payment verification occur at the same time. In another embodiment, account verification is performed before payment verification. Thereafter, account verification and payment verification are completed in step 916. The merchant then performs the waste collection service in step 918. After the waste collection service is complete, the server system sends a receipt of payment to the client device, which is step 920.

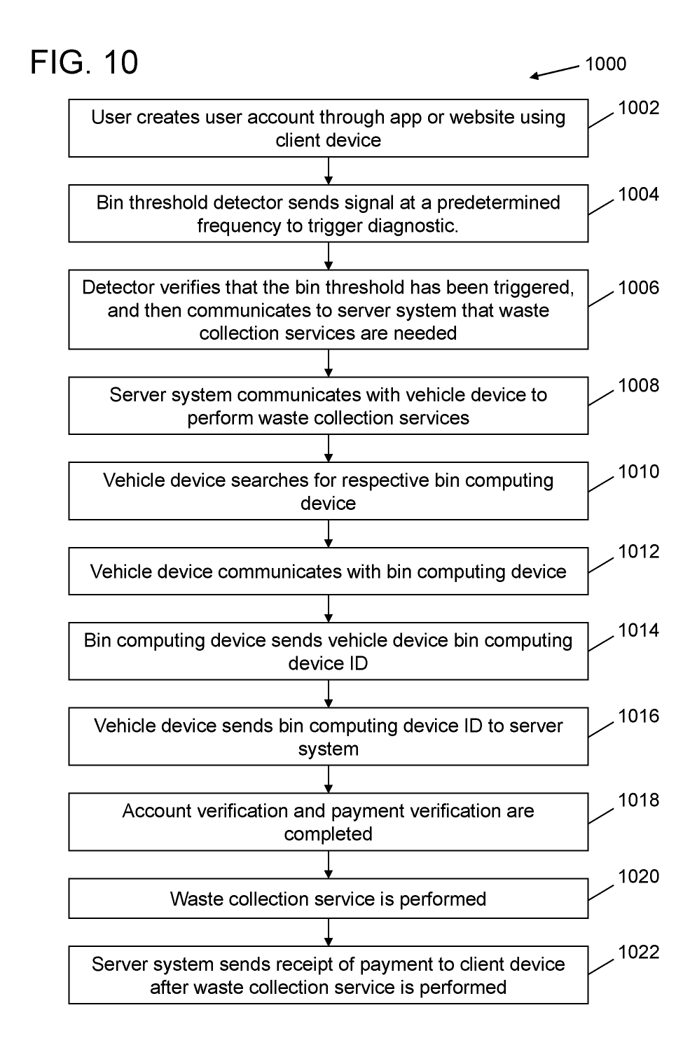

FIG. 10 is an example of yet another embodiment of a waste collection method 1000. In this embodiment, the bin detector within the bin computing device is configured to periodically determine whether the pre-determined amount of material is detected. The predetermined frequency can be set by the user. For example, the user may set the frequency to every 12 hours, wherein the bin computing device will perform a diagnostic every 12 hours to determine if the bin threshold has been applied.

In this embodiment, the user creates a user account through an app or website using the client device, which is step 1002. The bin detector within the bin computing device is configured to periodically determine whether the pre-determined amount of material is detected in step 1004. Next the detector verifies that the bin threshold has been triggered, and then communicates to server system that waste collection services are needed, which is step 1006. The server system then communicates with a vehicle device to perform waste collection services in step 1008. The vehicle device then searches for the respective bin in step 1010. Once the bin computing device is located, the merchant vehicle drives within a specified range of the bin computing device. The vehicle device then communicates with the bin computing device in step 1012. If the vehicle device communicates with a bin computing device outside the parameters of the appropriate geozone linked to the user account and bin computing device, no waste collection service will be rendered.

The bin computing device then sends the vehicle device the bin computing device ID through a response signal, which is step 1014. The vehicle device then sends the bin computing device ID to the server system for account verification and to payment verification in step 1016. In one embodiment, account verification and payment verification occur at the same time. In another embodiment, account verification is performed before payment verification. Thereafter, account verification and payment verification are completed in step 1018. The merchant then performs the waste collection service in step 1020. After the waste collection service is complete, the server system sends a receipt of payment to the client device, which is step 1022.

The present disclosure further includes a payment card system, such as a credit card payment system using the MasterCard® payment card system payment network (also referred to as an “interchange” or “interchange network”). The MasterCard® payment card system payment network is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.).

In the payment card system, a financial institution such as an issuer issues a payment card for an account, such as a credit card account or a debit card account, to a cardholder, who uses the payment card to tender payment for a purchase from a merchant. To accept payment with the payment card, the merchant must normally establish an account with a financial institution that is part of the financial payment system. This financial institution is usually called the “merchant bank” or the “acquiring bank” or “acquirer bank” or simply “acquirer”. When a cardholder tenders payment for a purchase with a payment card (also known as a financial transaction card), the merchant requests authorization from an acquirer for the amount of the purchase. Such a request is referred to herein as an authorization request message. The request may be performed over the telephone, but is usually performed through the use of a point-of-interaction terminal, also referred to herein as a point-of-sale device, which reads the cardholder's account information from the magnetic stripe on the payment card and communicates electronically with the transaction processing computers of the acquirer. Alternatively, the acquirer may authorize a third party to perform transaction processing on its behalf. In this case, the point-of-interaction terminal will be configured to communicate with the third party. Such a third party is usually called a “merchant processor” or an “acquiring processor.”

Using the payment card system payment network, the computers of the acquirer or the merchant processor will communicate with the computers of the issuer, to determine whether the cardholder's account is in good standing and whether the purchase is covered by the cardholder's available credit line or account balance. Based on these determinations, the request for authorization will be declined or accepted. If the request is accepted, an authorization code is issued to the merchant.

When a request for authorization is accepted, the available credit line or available balance of the cardholder's account is decreased. Normally, a charge is not posted immediately to a cardholder's account because bankcard associations, such as MasterCard International Incorporated®, have promulgated rules that do not allow a merchant to charge, or “capture,” a transaction until goods are shipped or services are delivered. When a merchant ships or delivers the goods or services, the merchant captures the transaction by, for example, appropriate data entry procedures on the point-of-interaction terminal. If a cardholder cancels a transaction before it is captured, a “void” is generated. If a cardholder returns goods after the transaction has been captured, a “credit” is generated.

For debit card transactions, when a request for authorization is approved by the issuer, the cardholder's account is decreased. Normally, a charge is posted immediately to the cardholder's account. The bankcard association then transmits the approval to the acquiring processor for distribution of goods/services, or information or cash in the case of an ATM.

After a transaction is captured, the transaction is settled between the merchant, the acquirer, and the issuer. Settlement refers to the transfer of financial data or funds between the merchant's account, the acquirer, and the issuer related to the transaction. Usually, transactions are captured and accumulated into a “batch,” which is settled as a group.

The system also provides tracking and reporting information regarding completed transactions and/or terminated transactions. Transaction information can be obtained from the client device, stored at the server system, and communicated to the user for recordkeeping purposes, for example. The system may be used for commercial purposes, or for residential purposes.

In one embodiment, the system inhibits fraudulent purchases by requiring specific pieces of information to be included in a transaction approval request message (e.g., authorization message) sent from the vehicle device. The required information includes user account data, a bin computing device ID, and a registered PAN in order to approve purchase transactions. Accordingly, transactions for services can be restricted to those associated with specific location data to reduce fraud.

The system described herein is configured to approve transactions made using a PAN having a bin computing device “registered” thereto using wireless communication, unique user account data, and/or the location (e.g., GPS coordinates) of the bin computing device and/or user in relation to the vehicle device. The system includes a server system including a processor in communication with a memory. In the example embodiment, a user first registers with the merchant by way of a merchant app and provides both account information (e.g., a PAN). In some embodiments, the PAN may be representative of one or more cardholder identifiers and/or cardholder account identifiers, which identify a payment account and one or more payment methods (e.g., physical card, chip card, tokenized device) associated with that payment account. The cardholder account identifiers may include device identifiers associated with each payment method, such as a phone number, email address, card number, token, or other similar contact information associated with a bin computing device or a client device. The unique vehicle identifiers may include bin ID numbers, VINs, or the like. In some embodiments, one PAN may be registered with multiple bin computing devices, and may therefore be associated with multiple bins and locations.

In a business setting, the owner of a business may register corporate payment accounts/cards and corresponding bin computing devices with the user account, which are stored in the server system. When a user (has a user computing device (e.g., a mobile device, smart phone, tablet, phablet, wearable smart device, etc.), the user may download a corresponding merchant app to the client device to access the waste collection and payment system. The app may allow the user to store registered payment account information and to perform waste collection related functionality programmatically via the device, such as initiating a transaction, obtaining a unique vehicle identifier of the merchant's nearby vehicle, providing the vehicle identifier and payment account information to the client, and/or receiving notifications of approved/declined transactions.

As will be appreciated based on the foregoing specification, the above-described embodiments of the disclosure may be implemented using computer programming or engineering techniques including computer software, firmware, hardware or any combination or subset thereof, wherein the technical effect is providing positioning determination using wireless and payment transactions data. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An automated waste collection system, said automated waste collection system in communication with a client device and a payment processor, said automated waste collection system comprising:
a vehicle device onboard a waste collection vehicle and comprising a vehicle transceiver, a first processor, and a first memory;
a bin computing device mounted to a waste collection bin and comprising a bin transceiver, a second processor, and a second memory; and
a geofence defined by location data;
wherein said vehicle device and said bin computing device are configured to communicate wirelessly with one another to verify, based on the geofence location data, a user account associated with a user that has requested a waste collection service.

2. The automated waste collection system according to claim 1, wherein said vehicle device is configured to selectively attach to the waste collection vehicle.

3. The automated waste collection system according to claim 1, wherein said bin computing device is configured to selectively attach to the waste collection bin.

4. The automated waste collection system according to claim 1, wherein said vehicle device is configured to communicate wirelessly with at least one of the payment processor, a card issuer, and the client device.

5. The automated waste collection system according to claim 1, wherein said bin computing device is configured to communicate wirelessly with at least one of the payment processor, a card issuer, and the client device.

6. The automated waste collection system according to claim 5, wherein said vehicle device is further configured to receive a bin computing device ID from said bin computing device, wherein the bin computing device ID is a unique identification number associated with said bin computing device.

7. The automated waste collection system according to claim 1, wherein the location data includes:
a user defined geofence zone;
a user defined geofence rule associated with the geofence zone; and
an account identifier of a user associated with the geofence zone, wherein the geofence zone is a geographic area, and wherein the geofence rule is a transaction limitation.

8. The automated waste collection system according to claim 1, wherein said vehicle device is configured to generate a notification signal, wherein the notification signal is generated when an account verification and a payment verification are successful.

9. The automated waste collection system according to claim 1, wherein said bin computing device is configured to detect when a pre-determined amount of material has been placed in the waste collection bin.

10. The automated waste collection system according to claim 1, wherein the pre-determined amount of material is the amount of waste it takes to completely fill the waste collection bin.

11. The automated waste collection system according to claim 9, wherein said bin computing device is configured to automatically transmit a signal to least one of the client device, the payment processor, and said vehicle device when the pre-determined amount of material is detected.

12. The automated waste collection system according to claim 9, wherein said bin computing device is configured to periodically determine whether the pre-determined amount of material is detected.

13. An automated waste collection method comprising:
receiving a communication from a client device requesting the scheduling of a waste collection service;
scheduling a waste collection service in response to the communication;
transmitting a signal to a vehicle device onboard a vehicle scheduled to perform the waste collection service;
communicating wirelessly with a bin computing device to perform the waste collection service; and
verifying a user account and verifying a payment.

14. The method according to claim 13, wherein said receiving a communication from a client device comprises linking a bin computing device ID with a user account, wherein the user account includes user identification data, location data, and payment data associated with a user and the bin computing device ID.

15. The method according to claim 13, wherein communicating wirelessly with a bin computing device comprises at least one of passive and active wireless communication.

16. The method according to claim 13, wherein scheduling a waste collection service comprises scheduling a waste collection service at least one of on demand, at a pre-determined frequency, and automatically once a pre-determined amount of material has been placed in a waste collection bin.

17. The method according to claim 13, wherein verifying a user account and verifying a payment comprises matching a token ID to the bin computing device, wherein the token ID is convertible into a personal account number associated with a user of the client device.

18. The method according to claim 13, further comprising sending a notification wirelessly to said client device when a waste collection service has been performed.

19. The method according to claim 13, further comprising transmitting a signal to a plurality of client devices associated with a plurality of user accounts within a defined geofence.

20. The method according to claim 13, wherein scheduling a waste collection service comprises processing user account data, including user identification data, zone data, payment data, location data, and map data.
